(19) United States
(12) Patent Application Publication
(10) Pub. No.: US 2025/0082134 A1
(43) Pub. Date: Mar. 13, 2025

(54) Stirring Device Applicable To Containers

(71) Applicant: Shenzhen DeOne Innovation Technology Co.,ltd, Shenzhen (CN)

(72) Inventor: Jiongjun Cai, Shenzhen (CN)

(21) Appl. No.: 18/677,808

(22) Filed: May 29, 2024

(30) Foreign Application Priority Data
Sep. 7, 2023 (CN) 2023224226574

(51) Int. Cl. A47J 43/08; A47J 43/044; B01F 27/13; B01F 27/96; B01F 35/222; B01F 35/32; B01F 101/06

(52) U.S. Cl. CPC A47J 43/082; A47J 43/044; B01F 27/13; B01F 27/96; B01F 35/222; B01F 35/3204; A47J 2043/04427; A47J 2043/04436; B01F 2101/06

(57) ABSTRACT

A stirring device applicable to containers is disclosed, which includes a power module, a control module and a driver module. The power module provides power for this whole device, the driver module is equipped with an output shaft, and the output shaft is connected to a stirring rod extending into an interior of the container. The control module has specific forward and reverse rotations program scheme, its specific operation mode is that, the stirring rod is controlled to rotate in one direction for a number of seconds or revolutions, and then followed by in an opposite direction for a number of seconds or revolutions, and such cycle is repeated again and again. A mixer adopting above technical solutions can well meet requirements of churning such as stable, low noise, fast, uniform, and non-foaming.

### TECHNICAL FIELD

The present application relates to the technical field of maternal and child supplies, and in particular to a stirring device applicable to containers.

### BACKGROUND

Currently, a variety of food mixers for maternal and child supplies have appeared on the market. However most of these food mixers have only one-way fast milk churning, so that such milk churning process is fast, but easy to foam and loud noise, its operation is unstable, and slow one-way mixing is likely to lead to uneven and insufficient mixing. Therefore, when existing food mixers are churning, their drive motors often fail to meet high control requirements of churning due to lack of a specialized churning control strategy.

### SUMMARY

In view of defects and deficiencies of existing technologies, the present disclosure aims to provide a stirring device applicable to containers, which can well meet requirements of milk churning such as stable, low noise, fast, uniform, and non-foaming by adopting a new type of milk churning control strategy.

To achieve above objectives, the present disclosure adopts following technical solutions. In some embodiments of the present disclosure, a stirring device applicable to containers is provided, which is detachably assembled on an opening of the container. And the stirring device includes a control module; a power module, electrically connected to the control module; and a driver module, electrically connected to the control module. Herein the driver module is provided with an output shaft and the output shaft is connected to a stirring rod extending into an interior of the container, the control module is configured to control the driver module to cycle through two rotation modes, one of the rotation modes is a forward rotation for a number of seconds or revolutions, and the other of the rotation modes is a reverse rotation for a number of seconds or revolutions.

The control module includes a forward rotation circuit, a reverse rotation circuit, and a circuit switching module electrically connected the two respectively; wherein the control module controls the driver module to perform the forward rotation after the forward rotation circuit is energized, and the control module controls the driver module to perform the reverse rotation after the reverse rotation circuit is energized; and where the circuit switching module is configured for energizing one of the forward rotation circuit and the reverse rotation circuit.

The driver module is a motor, and a current that the forward rotation circuit passes into the motor is opposite to a current that the reverse rotation passes into the motor.

The control module is a control circuit board and the circuit switching module is a master switch integrated in the control circuit board.

The two rotation modes are combined as the forward rotation for 10 s followed by the reverse rotation, and the reverse rotation for 10 s followed by the forward rotation.

The power module is a rechargeable battery or an external power supply.

The stirring device is further provided with a charging section, a charging socket is provided in the charging section that electrically connected to the control module, and the charging section is used to charge the rechargeable battery.

The stirring device is further provided with a housing and a cover, a cavity is provided in the housing for electronic components to be placed in, and the cover is provided on the cavity.

The stirring rod is disposed at a bottom of the housing, and the output shaft is connected with the stirring rod after goes across the housing.

The cover is further provided with a switch section electrically connected to the control module and the switch section controls on and off of the stirring device.

With adoption of above technical solutions, the stirring device applicable to containers of the present disclosure has at least following beneficial effects and advantages. By detachable provided the stirring device at the opening of a container, and the stirring device is provided with the power module, the control module and the driver module, herein the power module provides power for the whole device, and the driver module is equipped with the output shaft, which is connected with the stirring rod that extends from the opening of the container into the interior of the container. When the driver module drives the stirring rod to rotate, the stirring rod can stir in the container, and the control module has a milk churning strategy, which can perform the forward rotation for a number of seconds or revolutions followed by the reverse rotation for a number of seconds or revolutions, and then continue the forward rotation for a number of seconds or revolutions after completing the reverse rotation, and recycle such operations again and again, which can well meet requirements of milking churning such as stable, low noise, fast, uniform, and non-foaming.

### BRIEF DESCRIPTION OF THE DRA WINGS

In order to more clearly illustrate the technical solutions in the embodiments of the present disclosure or in the existing technologies, accompanying drawings to be used in the description of the embodiments or the existing technologies will be briefly introduced below. It will be obvious that the accompanying drawings in the following description are only some of the embodiments of the present disclosure, and for a person of ordinary skill in the art, other drawings may be obtained based on these accompanying drawings without paying creative labor.

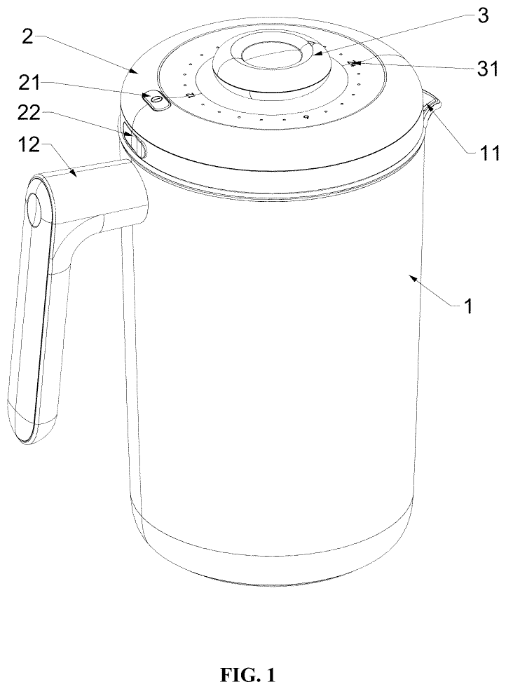

FIG. 1 shows a structural schematic diagram of a stirring device applicable to containers in accordance with some embodiments of the present disclosure.

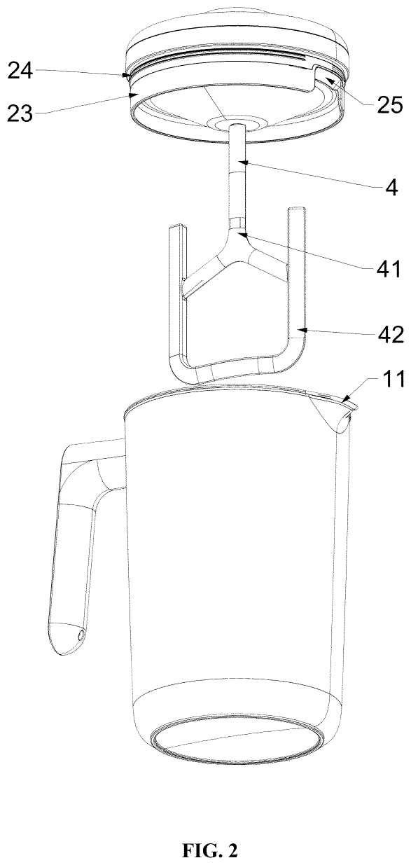

FIG. 2 shows a schematic diagram of a separation state of a housing and a container of the stirring device applicable to containers in accordance with some embodiments of the present disclosure.

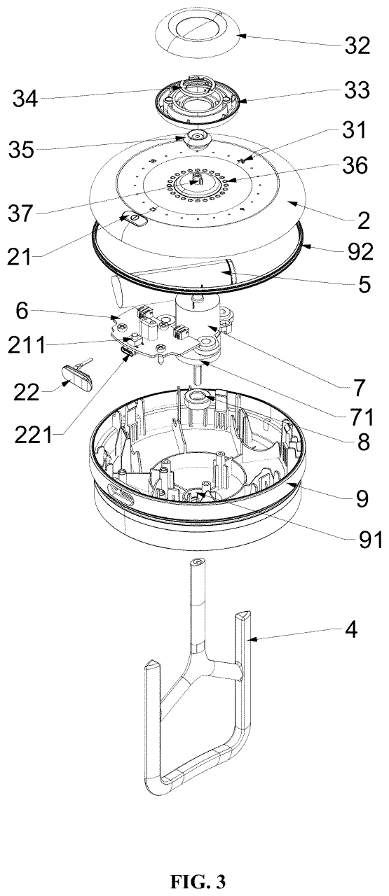

FIG. 3 shows an exploded view of the housing of the stirring device applicable to containers in accordance with some embodiments of the present disclosure.

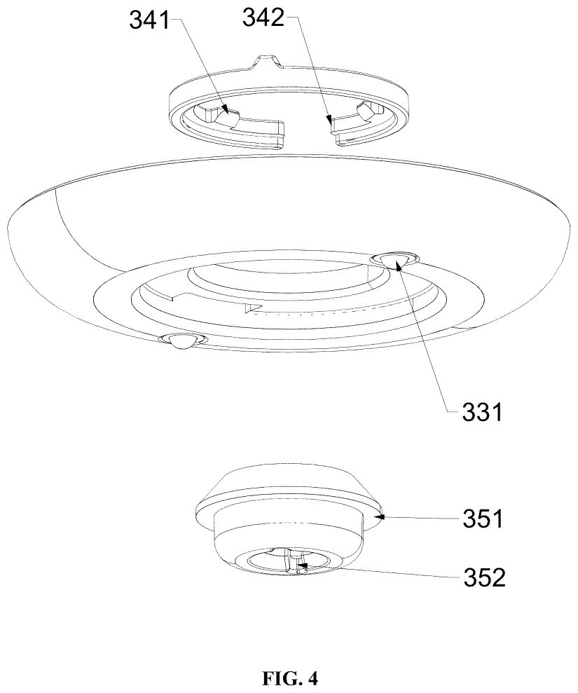

FIG. 4 shows an exploded view of partial structure of the stirring device applicable to containers in accordance with some embodiments of the present disclosure.

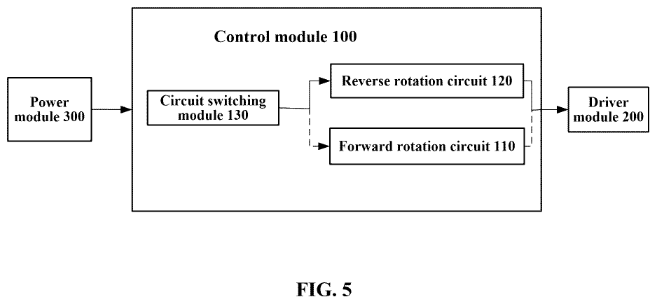

FIG. 5 shows a structural frame of the stirring device applicable to containers in accordance with some embodiments of the present disclosure.

In the drawings, reference signs are as follows. 1. Container, 11. Spout, 12. Grip, 2. Cover, 21. Switch section, 211. Power button, 22. Charging section, 221. Charging socket, 23. Sealing frame, 24. Sealing pattern, 25. Leakage port, 3. Timer, 31. Scale, 32. Upper cover, 33. Lower cover, 331. Positioning bead, 34. Clamping piece, 341. Clamping block, 342. Fracture, 35. Locating piece, 351. Locating edge, 352. Positioning socket, 36. Locating slot, 37. Positioning rod, 4. Stirring rod, 41. First stirring section, 42. Second stirring section, 5. Power module, 6. Control circuit board, 7. Driver module, 71. Reduction gear box, 8. Sealing gasket, 9. Housing, 91. Sealing seat, 92. Scaling ring, 100. Control module, 110. Forward rotation circuit, 120. Reverse rotation circuit, 130. Circuit switching module.

### DETAILED DESCRIPTION OF THE EMBODIMENTS

The present disclosure will be described in further detail below in conjunction with the accompanying drawings.

Specific embodiments are only explanations of the present disclosure, which are not a limitation of the present disclosure, and for a person of ordinary skill in the art, may make modifications to these embodiments without creative contribution according to needs after reviewing of this specification, but as long as it is within the scope of appending claims of the present disclosure, it shall be protected by the Patent Law.

As shown in FIG. 1, FIG. 2 and FIG. 5, in some embodiments of the present disclosure, a stirring device applicable to containers 1 is provided, which includes a cover 2 and a housing 9. Herein a cavity is provided in the housing 9 for electronic components to be placed in, an exposed hole is opened at a top of the housing 9 for cavity to be exposed, and the cover 2 is adapted to the exposed hole in a size. When the cover 2 is covered on the exposed hole, the cover 2 and the housing 9 form a space for the electronic components to be mounted, and the cover 2 is fixedly assembled to the housing 9 by screws or bolts. A sealing gasket 8 is provided at a seam crossing of the cover 2 and the housing 9, thereby improving the sealing of the cover 2 and the housing 9 after assembled. In some other embodiments, the cover 2 and the housing 9 are assembled by fasteners. In an example, the cover 2 and the housing 9 are integrally molded.

It is to be added that, in the stirring device of the present disclosure, that is, in the cavity of the housing 9, it is provided with a control module 100, a power module 5, and a driver module 7. Herein the driver module 7 is provided with an output shaft, and the output shaft is connected to a stirring rod 4, one end of the stirring rod 4 is detachably assembled with the output shaft that goes across the cavity of the housing 9 to an outside of the housing 9. When in use, the entire stirring device is assembled at an opening of a container 1, at this time the stirring rod 4 is also extended into an interior of the container 1. And when the control module 100 controls rotations of the driver module 7, the output shaft will drive the stirring rod 4 to rotate in the container 1, so as to carry out stirring in the interior of the container 1.

Preferably, the control module 100 is configured to control the driver module 7 to cycle through two rotation modes, one of the rotation modes is a forward rotation for a number of seconds or revolutions, and the other of the rotation modes is a reverse rotation for a number of seconds or revolutions. Therefore, the two rotation modes are cyclic, that is, the forward rotation for a number of seconds or revolutions followed by the reverse rotation for a number of seconds or revolutions, and the reverse rotation is completed to continue the forward rotation, and repeat such operations again and again.

It should be noted that, the control module 100 includes a forward rotation circuit 110, a reverse rotation circuit 120, and a circuit switching module 130 electrically connected the two respectively. Herein the control module 100 controls the driver module 7 to perform the forward rotation after the forward rotation circuit 110 is energized, so that the stirring rod 4 is rotated with the forward rotation in the container 1. The control module 100 controls the driver module 7 to perform the reverse rotation after the reverse rotation circuit 120 is energized, so that the stirring rod 4 is rotated with the reverse rotation in the container 1. The circuit switching module 130 is configured for energizing either of the forward rotation circuit 110 and the reverse rotation circuit 120, here an energized logic is that, the forward rotation circuit 110 is energized for 10 s and stops energizing, and then the reverse rotation circuit 120 is energized for 10 s, then the reverse rotation circuit 120 is energized for 10 s followed by the forward rotation circuit 110 is energized for 10 s again, and repeat such operations again and again.

Referring to FIG. 3, the driver module 7 is a motor, and a current that the forward rotation circuit 110 passes into the motor is opposite to a current that the reverse rotation passes 120 into the motor. By changing a direction of the current to control the forward rotation or the reverse rotation of the motor, so that a reorientation of the forward rotation or the reverse rotation of the motor is faster and more stable. Moreover, the output shaft of the motor is provided toward a bottom and is threaded from the cavity of the housing 9 across the outside of the housing 9. A sealing seat 91 is provided on a threaded portion of the housing 9, and a sealing ring 92 is provided in the scaling seat 91 for the output shaft to be threaded, the sealing ring 92 cooperates with the sealing seat 91 to effectively improve the sealing of the threaded portion of the housing 9. The control module 100 is a control circuit board 6 and the circuit switching module 130 is a master switch integrated in the control circuit board 6. The power module 5 is a rechargeable battery. In some other embodiments, the power module 5 is a disposable dry battery, or the power module 5 may be an external power supply.

It is to be added that, the stirring device is further provided with a charging section 22. Specifically, the charging section 22 is provided at a side of the housing 9, a charging socket 221 is provided in the charging section 22 that electrically connected to the control module 100, by plugging a charging cable into the charging socket 221, it can be realized that the charging section 22 is used for charging the rechargeable battery.

In the embodiments, the rechargeable battery is a lithium battery, and a part of the charging section 22 is a charging hole opened on the side of the housing 9, and the other part of the charging section 22 is a silicone sealing cover, with one end of the silicone sealing cover is embedded in the side of the housing 9, and the other end of the silicone sealing cover covers the charging hole, thereby improving the sealing of the whole charging section 22. The charging socket 221 is provided on the control circuit board 6 and is arranged towards the charging hole, so as to allow the charging cable to be plugged in the charging socket 221 is preferably a type-c interface, and may also be a USB-c interface, or a Micro USB interface.

Preferably, the cover 2 is also provided with a switch section 21 electrically connected to the control module 100, a part of the switch section 21 is a pressing section provided on the cover 2, and the other part of the switch section 21 is a power button 211 provided on the control circuit board 6, and the power button 211 is located at the bottom of the pressing section. When a user pushes the pressing section, the power button 211 is also pushed, and the stirring device can then be controlled to on or off.

It should be noted that, the container 1 applicable to the stirring device of the present disclosure has a cup-shape, an opening is provided at a top of the container 1, and the opening of the container 1 has a diameter greater than or equal to the diameter of the bottom of the container 1. A spout 11 is provided at an edge of the opening of the container 1 and the spout 11 is provided protrudingly and connected to a space inside the container 1. A grip 12 is provided at a side of the container 1, and the grip 12 facilitates the user to move the whole container 1.

Preferably, a sealing frame 23 is provided at a bottom edge of the housing 9, the diameter of the sealing frame 23 is adapted to the diameter of the opening of the container 1. When the sealing frame 23 is inserted into the opening of the container 1, the sealing frame 23 will be adhered to the inner wall of the opening of the container 1. A plurality of sealing patterns 24 are provided at the top of the sealing frame 23, the scaling patterns 24 is of a flexible material, which can be pressed against the inner side wall of the opening of the container 1 after the sealing frame 23 is inserted into the opening of the container 1, so as to further improve the sealing of the stirring device after it extended into the container 1. A leakage port 25 is provided on the side of the scaling frame 23, the leakage port 25 is set in a shape of notch on the sealing frame 23, and a size of the notch is adapted to the spout 11. After the leakage port 25 is aligned with the spout 11, the whole container 1 is tilted, at this time the liquid or powder inside the container 1 can be poured out of the container 1 through the spout 11. And when the leakage port 25 is not facing the spout 11, the whole container 1 is in an airtight state, which can effectively prevent the liquid or powder from spilling out of the opening or the spout 11 of the container 1 during the working process of the stirring device.

Referring to FIG. 3 and FIG. 4, a timer 3 is provided on the top of the cover 2, the timer 3 is rotationally provided on the top of the cover 2. A plurality of scales 31 are engraved on the top of the cover 2, all scales 31 form a clock-like dial plate, and each of the scales 31 corresponds to one time, the timer 3 is provided in the center of the dial plate, the timer 3 is engraved with a logo, the logo can be aligned to any of the scales 31 when the user rotates the timer 3, thus marking an arbitrary time for the user to know when the stirring device starts to run or stops to run.

It is to be added that, the timer 3 is consist of an upper cover 32 and a lower cover 33, the lower cover 33 is provided with at least one positioning beads 331 at its bottom surface, and a plurality of locating slots 36 uniformly arranged in a circle are provided on a top surface of the cover 2, the locating slots 36 are used for positioning beads 331 to be stuck therein, so as to prevent the timer 3 from slipping when the timer 3 is marking the scales 31. The number of the locating slots 36 is the same as the number of the scales 31, thus each of the locating slots 36 corresponds to one time scale 31, so that the timer 3 can more accurate for the time of marking.

Preferably, the cavity is formed between the upper cover 32 and the lower cover 33, the clamping piece 34 is sandwiched between the upper cover 32 and the lower cover 33 in the cavity. The lower cover 33 is opened with a through hole at its bottom, and the through hole is used for insertion of the locating piece 35, then the inserted locating piece 35 is embedded in the clamping piece 34 and can be rotated relative to the locating piece 35. A positioning socket 352 is provided at the bottom of the locating piece 35, and a positioning rod 37 inserted and fixed in the positioning socket 352 is provided on the cover 2, so that when the timer 3 is rotated, the locating piece 35 cooperates with the clamping piece 34 to prevent the timer 3 from falling off and is available for the timer 3 to be rotated on the cover 2.

It is to be added that, the locating piece 35 is provided with two sections, a first section of which is used for the positioning rod 37 to be threaded, this section is the positioning socket 352, after the positioning socket 352 is inserted into the positioning rod 37, both of them are fixedly assembled without circumferential slippage, thus avoiding loosening of the two. A second section is inserted into the clamping piece 34 and then resist the clamping piece 34, preventing the locating piece 35 from falling out of the clamping piece 34, this section is provided in a form of a circular platform, and its cross-sectional area increases step by step from the top to the bottom, and the bottom of this section is provided with a cylindrical member, the cylindrical member is hollow, this hollow portion is the positioning socket 352, and the diameter of the cylindrical member is smaller than the diameter of the bottom of this section.

In the embodiments, the clamping piece 34 is a ring piece, a plurality of clamping blocks 341 is provided in an inner wall of the ring piece. The plurality of clamping blocks 341 form a second inner diameter of the ring piece at it end, the second inner diameter is smaller than the diameter of the bottom of the second section of the locating piece 35, thereby facilitating the insertion of the locating piece 35 into the ring piece. The ring piece may deform when the locating piece 35 is inserted, thereby for the second section of the locating piece to pass throughout the clamping block 341 on the ring piece. After the second section of the locating piece 35 is embedded in the ring piece, the first section of the locating piece 35 fits against the clamping block 341, thereby preventing the second section from disengaging from the snap of the ring piece, to allow for the upper cover 32 and the lower cover 22 of the entire timer 3 is assembled on the cover 2. Preferably, the clamping block 341 is provided with a bevel in a direction of insertion of the locating piece 35, the bevel is available for the second section of the locating piece 35 to be inserted more easily into the ring piece.

Preferably, the ring piece is provided with a fracture 342, to allow the ring piece to deform when the locating piece 35 is inserted, thereby facilitating the insertion of the locating piece 35.

Referring to FIG. 2 and FIG. 3, the stirring rod 4 is disposed at the bottom of the output shaft, a top of the stirring rod 4 is provided with a hole, the shape of which is adapted to the output shaft for the insertion of the output shaft into the stirring rod 4. It can realize a fixed assembly of the output shaft and the stirring rod 4 after the output shaft is inserted into the stirring rod 4, and the stirring rod 4 can be driven to carry out stirring operations in the container 1 through the rotation of the output shaft. In the embodiments, the output shaft of the motor is connected to a reduction gear box 71, the output shaft of the motor is connected to an input end of the reduction gear box 71 in a transmission connection, and an output end of the reduction gear box 71 is connected to the stirring rod 4, so as to enable a rotation speed of the stirring rod 4 to be reduced, and to prevent excessive speed from leading to the breakage of the stirring rod 4.

Preferably, the stirring rod 4 is provided with a first stirring section 41 and a second stirring section 42. One end of the first stirring section 41, that is, it top, is connected to the output end of the reduction gear box 71, that is, an aperture is opened at the top of the first stirring section 41. The other end of the first stirring section 41, that is, its bottom, is provide with a plurality of forks at the bottom. Specifically, the forks are all provided towards the inner side wall of the container 1. The second stirring section 42 is provided in a form of a rod and is connected to ends of the forks, so as to make a stirring range of the stirring rod 4 inserted into the container 1 increase, and also make the stirring inside the container 1 more adequate and even.

Specifically, the first stirring section 41 is a A-shaped rotating rod, and the second stirring section 42 is a U-shaped stirring rod. A connection between a rotating rod and the stirring rod is located in a middle inner edge of the stirring rod, and the rotating rod and the stirring rod are integrally molded, and they are both made of PP or ABS.

The foregoing description is only for the purpose of illustrating the technical solutions of the present disclosure, but not a limitation thereto. Any other modifications or equivalent replacements made by the person of ordinary skill in the art for the present disclosure, as long as does not deviate from the concept of the technical solutions of the present disclosure, shall be covered by appending claims of the present invention.

What is claimed is:

1. A stirring device applicable to containers, detachably assembled on an opening of the container, and the stirring device comprising:
a control module;
a power module, electrically connected to the control module; and
a driver module, electrically connected to the control module; wherein the driver module is provided with an output shaft and the output shaft is connected to a stirring rod extending into an interior of the container, the control module is configured to control the driver module to cycle through two rotation modes, one of the rotation modes is a forward rotation for a number of seconds or revolutions, and the other of the rotation modes is a reverse rotation for a number of seconds or revolutions.

2. The stirring device applicable to containers according to claim 1, wherein the control module comprises a forward rotation circuit, a reverse rotation circuit, and a circuit switching module electrically connected the two respectively; wherein the control module controls the driver module to perform the forward rotation after the forward rotation circuit is energized, and the control module controls the driver module to perform the reverse rotation after the reverse rotation circuit is energized; and wherein the circuit switching module is configured for energizing one of the forward rotation circuit and the reverse rotation circuit.

3. The stirring device applicable to containers according to claim 2, wherein the driver module is a motor, and a current that the forward rotation circuit passes into the motor is opposite to a current that the reverse rotation passes into the motor.

4. The stirring device applicable to containers according to claim 2, wherein the control module is a control circuit board and the circuit switching module is a master switch integrated in the control circuit board.

5. The stirring device applicable to containers according to claim 1, wherein the two rotation modes are combined as the forward rotation for 10 s followed by the reverse rotation, and the reverse rotation for 10 s followed by the forward rotation.

6. The stirring device applicable to containers according to claim 1, wherein the power module is a rechargeable battery or an external power supply.

7. The stirring device applicable to containers according to claim 6, wherein the stirring device is further provided with a charging section, a charging socket is provided in the charging section that electrically connected to the control module, and the charging section is used to charge the rechargeable battery.

8. The stirring device applicable to containers according to claim 1, wherein the stirring device is further provided with a housing and a cover, a cavity is provided in the housing for electronic components to be placed in, and the cover is provided on the cavity.

9. The stirring device applicable to containers according to claim 8, wherein the stirring rod is disposed at a bottom of the housing, and the output shaft is connected with the stirring rod after goes across the housing.

10. The stirring device applicable to containers according to claim 8, wherein the cover is further provided with a switch section electrically connected to the control module, and the switch section controls on and off of the stirring device.
